(19) United States
(12) Patent Application Publication
(10) Pub. No.: US 2026/0245582 A1
(43) Pub. Date: Aug. 20, 2026

(54) Dual Free Layer Reader with Rear Soft Bias Design with Improved Soft Bias Stability

(71) Applicant: Western Digital Technologies, Inc., San Jose, CA (US)

(72) Inventors: Xiaoyong LIU, San Jose, CA (US); Songzi WANG, Shenzhen (CN); Goncalo Marcos BAIÃO DE ALBUQUERQUE, San Jose, CA (US); Yunfei DING, Fremont, CA (US)

(73) Assignee: Western Digital Technologies, Inc., San Jose, CA (US)

(21) Appl. No.: 19/233,582

(22) Filed: Jun. 10, 2025

(30) Foreign Application Priority Data
Feb. 20, 2025 (CN) 202510191648.X

(51) Int. Cl. G11B 5/39; G11B 5/31

(52) U.S. Cl. CPC G11B 5/3912; G11B 5/3932; G11B 5/398

(57) ABSTRACT

The present disclosure generally relates to a dual free layer (DFL) read head. The DFL read head comprises a first shield, a DFL sensor disposed on the first shield, soft bias (SB) side shields disposed adjacent to the DFL sensor on the first shield, a second shield disposed over the DFL sensor and SB side shields, and a rear soft bias (RSB) structure disposed adjacent to the DFL sensor, the RSB structure being recessed from a media facing surface. The RSB structure has a greater height than a width. The SB side shields comprise a first SB layer, a non-magnetic layer, and a second SB layer, the first and second SB layers being magnetically decoupled. The first SB layer is disposed in contact with a magnetic seed layer of the first shield. One of the first or second shields is synthetic anti-ferromagnetically pinned.

### BACKGROUND OF THE DISCLOSURE

### Field of the Disclosure

Embodiments of the present disclosure generally relate to a dual free layer (DFL) read head.

### Description of the Related Art

The heart of the functioning and capability of a computer is the storing and writing of data to a data storage device, such as a magnetic media drive (e.g., hard disk drive (HDD)). The HDD has a head comprising a reader (e.g., read head) and a writer (e.g., write head) that each has shields that capture stray fields, such as in the read head, or improve field gradient, such as in the write head.

Over the past few years, various magnetic recording methods have been studied to improve the areal density of a magnetic media device. Magnetic heads in HDDs can have a significant effect on the overall performance and reliability of the recording device. Magnetic heads may be designed to achieve specific advantages, such as improved performance.

One example design involves dual free layer (DFL) read heads or readers. In DFL reader operation, the two free layers are individually stabilized longitudinally by an antiferromagnetically coupled (AFC) soft bias (SB) side shields and biased transversally by a permanent magnet or a rear hard bias structure (RHB) structure from the stripe back edge of the sensor. However, the RHB structure generally has weaker inter-granular exchange coupling, resulting in an increased transverse bias variation and reducing both magnetic stability and hence poor asymmetric scattering control.

Therefore, there is a need in the art for an improved DFL read head.

### SUMMARY OF THE DISCLOSURE

The present disclosure generally relates to a dual free layer (DFL) read head. The DFL read head comprises a first shield, a DFL sensor disposed on the first shield, soft bias (SB) side shields disposed adjacent to the DFL sensor on the first shield, a second shield disposed over the DFL sensor and SB side shields, and a rear soft bias (RSB) structure disposed adjacent to the DFL sensor, the RSB structure being recessed from a media facing surface. The RSB structure has a height greater than a width. The SB side shields comprise a first SB layer, a non-magnetic layer, and a second SB layer, the first and second SB layers being magnetically decoupled. The first SB layer is disposed in contact with a magnetic seed layer of the first shield, and the second SB layer is disposed in contact with a magnetic seed layer of the second shield. One of the first or second shields is synthetic anti-ferromagnetically pinned.

In one embodiment, a read head comprises a first shield layer, an anti-ferromagnetic (AFM) layer disposed on the first shield layer, a magnetic seed layer disposed over the AFM layer, a dual free layer (DFL) sensor disposed over the magnetic seed layer at a media facing surface (MFS), soft bias (SB) side shields disposed adjacent to the DFL sensor, each of the SB side shields comprising: a first SB layer disposed in contact with the magnetic seed layer, a non-magnetic layer disposed in contact with the first SB layer, and a second SB layer disposed in contact with the non-magnetic layer, a second shield layer disposed over the DFL sensor and SB side shields, and a rear soft bias (RSB) structure disposed adjacent to the DFL sensor and SB side shields, the RSB structure being recessed from the MFS.

In another embodiment, a read head comprises a first shield comprising: an anti-ferromagnetic (AFM) layer, a first shield layer disposed on the AFM layer, an anti-ferromagnetically coupled (AFC) layer disposed on the first shield layer, and a magnetic seed layer disposed on the AFC layer, a dual free layer (DFL) sensor disposed on the first shield at a media facing surface (MFS), soft bias (SB) side shields disposed adjacent to the DFL sensor, each of the SB side shields comprising: a first SB layer disposed in contact with the magnetic seed layer, a non-magnetic layer disposed in contact with the first SB layer, and a second SB layer disposed in contact with the non-magnetic layer, a second shield disposed over the DFL sensor and SB side shields, and a rear soft bias (RSB) structure disposed adjacent to the DFL sensor and SB side shields, the RSB structure being recessed from the MFS.

In yet another embodiment, a read head comprises a first shield comprising: an anti-ferromagnetic (AFM) layer, and a magnetic seed layer disposed over the AFM layer, a dual free layer (DFL) sensor disposed on the first shield at a media facing surface (MFS), soft bias (SB) side shields disposed adjacent to the DFL sensor, each of the SB side shields comprising: a first SB layer disposed in contact with the magnetic seed layer, a non-magnetic spacer disposed on the first SB layer, and a second SB layer disposed on the non-magnetic spacer, a second shield disposed over the DFL sensor and SB side shields, the second shield comprising: a first shield layer, an anti-ferromagnetically coupled (AFC) layer disposed on the first shield layer, and a second shield layer disposed in contact with the AFC layer, and a rear soft bias (RSB) structure disposed adjacent to the DFL sensor and SB side shields, the RSB structure being recessed from the MFS.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of certain embodiments of a magnetic media drive including a magnetic recording head.

FIG. 2 is a fragmented, cross-sectional side view of certain embodiments of a read/write head.

FIG. 3 illustrates a top view of a conventional read head without a top shield.

FIGS. 4A-4C illustrate top views of read heads, according to various embodiments.

FIGS. 5A-5B illustrate MFS views of read heads, according to various embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a dual free layer (DFL) read head. The DFL read head comprises a first shield, a DFL sensor disposed on the first shield, soft bias (SB) side shields disposed adjacent to the DFL sensor on the first shield, a second shield disposed over the DFL sensor and SB side shields, and a rear soft bias (RSB) structure disposed adjacent to the DFL sensor, the RSB structure being recessed from a media facing surface. The RSB structure has a greater height than width. The SB side shields comprise a first SB layer, a non-magnetic layer, and a second SB layer, the first and second SB layers being magnetically decoupled. The first SB layer is disposed in contact with a magnetic seed layer of the first shield. One of the first or second shields is synthetic anti-ferromagnetically pinned.

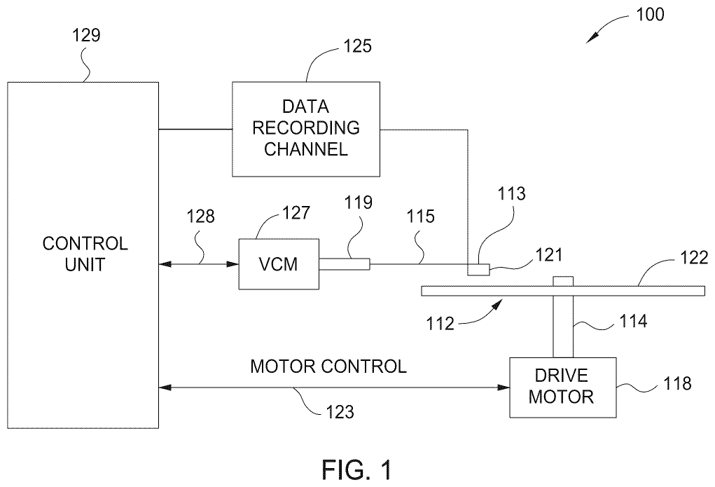

FIG. 1 is a schematic illustration of certain embodiments of a magnetic media drive 100 including a magnetic recording head having a SOT MTJ device. Such a magnetic media drive may be a single drive or comprise multiple drives. For the sake of illustration, a single disk drive 100 is shown according to certain embodiments. As shown, at least one rotatable magnetic disk 112 is supported on a spindle 114 and rotated by a drive motor 118. The magnetic recording on each magnetic disk 112 is in the form of any suitable patterns of data tracks, such as annular patterns of concentric data tracks (not shown) on the magnetic disk 112.

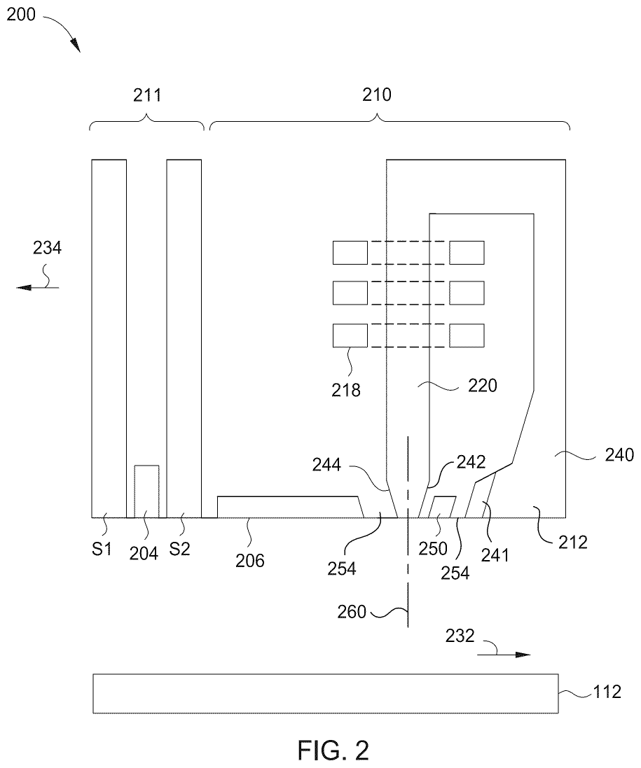

At least one slider 113 is positioned near the magnetic disk 112, each slider 113 supporting one or more magnetic head assemblies 121 that include a SOT device. As the magnetic disk 112 rotates, the slider 113 moves radially in and out over the disk surface 122 so that the magnetic head assembly 121 may access different tracks of the magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator means 127. The actuator means 127 as shown in FIG. 2 may be a voice coil motor (VCM). The VCM includes a coil movable within a fixed magnetic field, the direction and speed of the coil movements being controlled by the motor current signals supplied by control unit 129.

During operation of the disk drive 100, the rotation of the magnetic disk 112 generates an air bearing between the slider 113 and the disk surface 122 which exerts an upward force or lift on the slider 113. The air bearing thus counter-balances the slight spring force of suspension 115 and supports slider 113 off and slightly above the disk surface 122 by a small, substantially constant spacing during normal operation.

The various components of the disk drive 100 are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads on the assembly 121 by way of recording channel 125.

The above description of a typical magnetic media drive and the accompanying illustration of FIG. 1 are for representation purposes only. It should be apparent that magnetic media drives may contain a large number of media, or disks, and actuators, and each actuator may support a number of sliders.

It is to be understood that the embodiments discussed herein are applicable to a data storage device such as a hard disk drive (HDD) as well as a tape drive such as a tape embedded drive (TED) or an insertable tape media drive. An example TED is described in co-pending patent application titled “Tape Embedded Drive,” US. application Ser. No. 16/365,034, filed Mar. 31, 2019, assigned to the same assignee of this application, which is herein incorporated by reference. As such, any reference in the detailed description to an HDD or tape drive is merely for exemplification purposes and is not intended to limit the disclosure unless explicitly claimed. For example, references to disk media in an HDD embodiment are provided as examples only, and can be substituted with tape media in a tape drive embodiment. Furthermore, reference to or claims directed to magnetic recording devices or data storage devices are intended to include at least both HDD and tape drive unless HDD or tape drive devices are explicitly claimed. In addition, the various embodiments disclosed herein may be used as part of magnetic field sensors generally, outside of the magnetic sensing application in data storage devices.

FIG. 2 is a fragmented, cross-sectional side view of certain embodiments of a read/write head 200 having a SOT device. The read/write head 200 faces a magnetic media 112. The read/write head 200 may correspond to the magnetic head assembly 121 described in FIG. 1. The read/write head 200 includes a media facing surface (MFS) 212, such as a gas bearing surface, facing the disk 112, a write head 210, and a magnetic read head 211. As shown in FIG. 2, the magnetic media 112 moves past the write head 210 in the direction indicated by the arrow 232 and the read/write head 200 moves in the direction indicated by the arrow 234. In some embodiments, the magnetic read head 211 is a magnetoresistive (MR) read head that includes an MR sensing element 204 located between MR shields S1 and S2. In other embodiments, the magnetic read head 211 is a magnetic tunnel junction (MTJ) read head that includes a MTJ sensing device 204 located between MR shields S1 and S2. The magnetic fields of the adjacent magnetized regions in the magnetic disk 112 are detectable by the MR (or MTJ) sensing element 204 as the recorded bits.

The write head 210 includes a main pole 220, a leading shield 206, a trailing shield 240, an optional spin orbital torque (SOT) device 250, and a coil 218 that excites the main pole 220. The coil 218 may have a “pancake” structure which winds around a back-contact between the main pole 220 and the trailing shield 240, instead of a “helical” structure shown in FIG. 2. When included, e.g., to achieve a Microwave Assisted Magnetic Recording (MAMR) effect, the SOT device 250 is formed in a gap 254 between the main pole 220 and the trailing shield 240. The main pole 220 includes a trailing taper 242 and a leading taper 244. The trailing taper 242 extends from a location recessed from the MFS 212 to the MFS 212. The leading taper 244 extends from a location recessed from the MFS 212 to the MFS 212. The trailing taper 242 and the leading taper 244 may have the same degree of taper, and the degree of taper is measured with respect to a longitudinal axis 260 of the main pole 220. In some embodiments, the main pole 220 does not include the trailing taper 242 and the leading taper 244. Instead, the main pole 220 includes a trailing side (not shown) and a leading side (not shown), and the trailing side and the leading side are substantially parallel. The main pole 220 may be a magnetic material, such as a FeCo alloy. The leading shield 206 and the trailing shield 240 may be a magnetic material, such as a NiFe alloy. In certain embodiments, the trailing shield 240 can include a trailing shield hot seed layer 241. The trailing shield hot seed layer 241 can include a high moment sputter material, such as CoFeN, FeXN, or FeX, where X includes at least one of N, Al, Ni, Co, Ta, Re, Ir, Pt, Rh, Ta, Zr, and Ti. In certain embodiments, the trailing shield 240 does not include a trailing shield hot seed layer.

In other embodiments, instead of an SOT device 250 it may be a conductive stack in the write gap. In certain embodiments, the read/write head 200 additionally includes mechanisms (not shown) for supporting Heat Assisted Magnetic Recording (HAMR), which may include a waveguide coupled to a light source and a near field transducer (NFT) placed adjacent to the main pole 220 and coupled to the waveguide to convert the delivered light into a heating spot on the media.

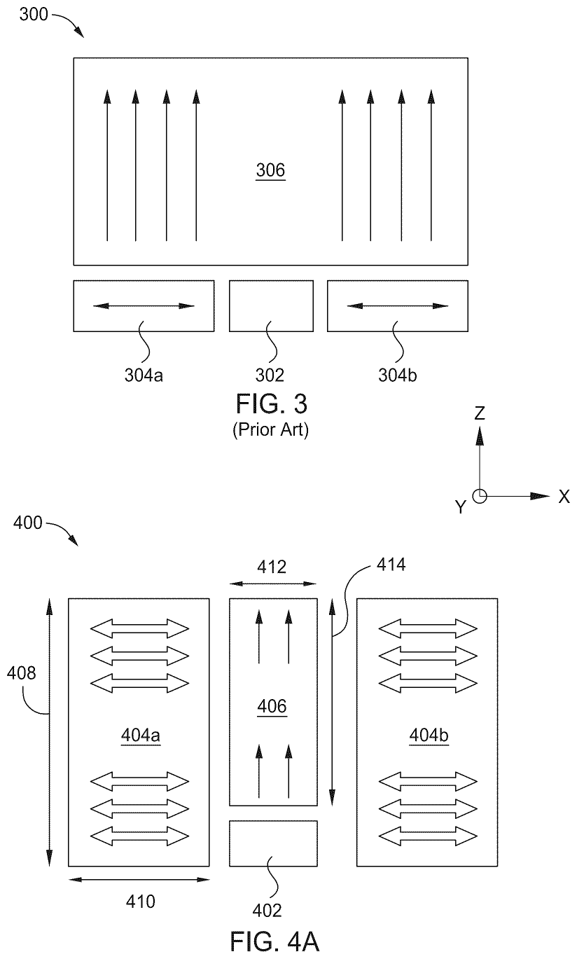

FIG. 3 illustrates a top view of a conventional read head 300 without a top shield. The conventional read head 300 comprises a dual free layer (DFL) sensor 302 disposed at a media facing surface (MFS), first and second synthetic anti-ferromagnetic (SAF) soft bias (SB) side shields 304a, 304b disposed adjacent to the DFL sensor 302 at the MFS, and a rear hard bias (RHB) structure disposed behind the DFL sensor and SAF SB side shields 304a, 304B recessed from the MFS. The DFL sensor 302 and the SAF SB side shields 304a, 304b have substantially the same height in the z-direction. The RHB structure 306 has a greater height in the z-direction and a greater width in the x-direction than both the DFL sensor 302 and the SAF SB side shields 304a, 304b.

The RHB structure generally has weaker inter-granular exchange coupling, resulting in an increased transverse bias variation and reducing magnetic stability with poor asymmetric scattering control. This results in the conventional read head 300 being less accurate at reading data and reduces the overall performance of the conventional read head.

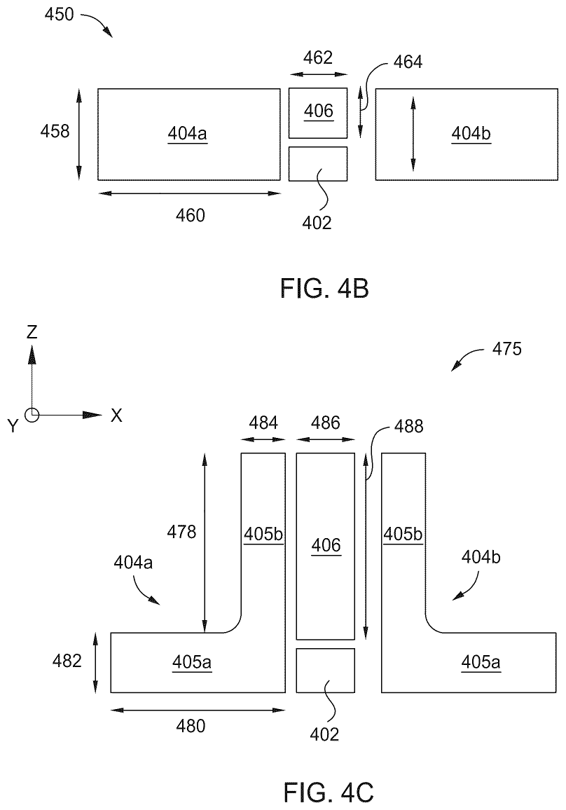

FIGS. 4A-4C illustrate top views of read heads 400, 450, 475, according to various embodiments. A top shield is not shown for clarity. The read heads 400, 450, 475 may each individually be a part of the magnetic media drive 100 of FIG. 1. The read heads 400, 450, 475 may each individually be a part of the read/write head 200 of FIG. 2, such as the read head 211.

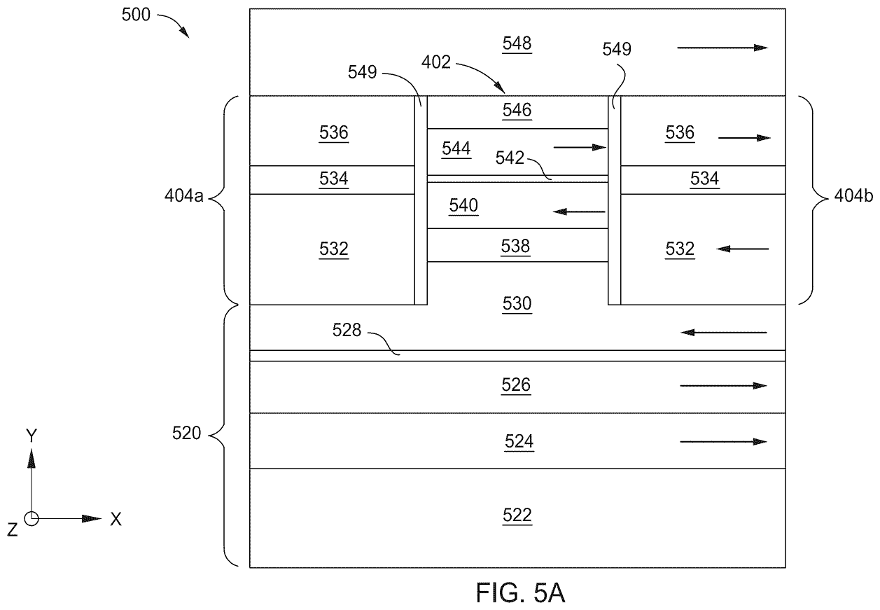

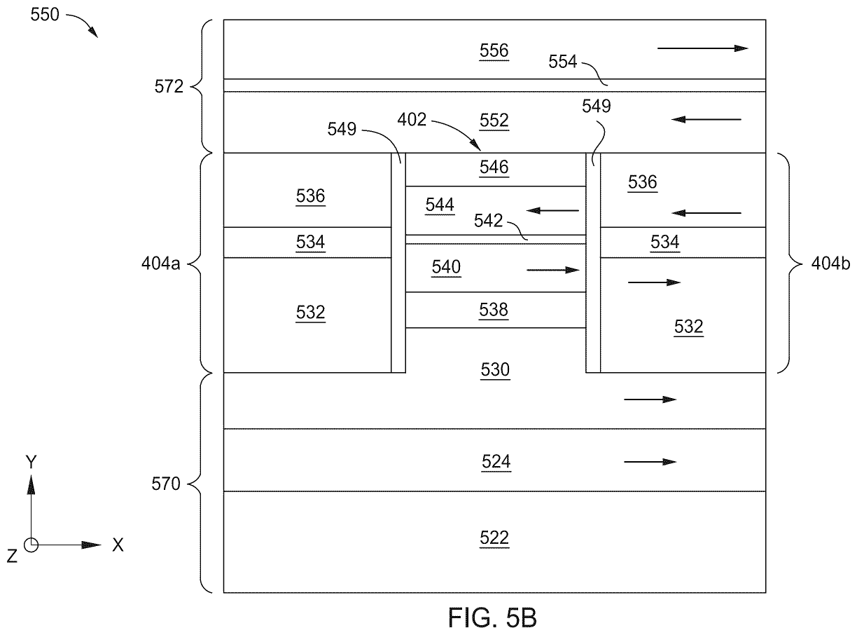

Each read head 400, 450, 475 comprises a DFL sensor 402 disposed at the MFS, SB side shields 404a, 404b disposed adjacent to the DFL sensor 402 at the MFS, and a RSB structure 406 disposed adjacent to the sensor 402 recessed from the MFS. The RSB structure 406 comprises soft ferromagnetic magnetic materials, such as Ni, Fe, Co, or combination thereof. The RSB structure 406 can be optionally pinned along a transverse direction by adding an AFM layer (not shown) below or above the RSB structure 406. Materials of the sensor 402 and the SB side shields 404a, 404b are discussed below in FIGS. 5A-5B.

In the read head 400 of FIG. 4A, the SB side shields 404a, 404b each has a height 408 in the z-direction of about 500 nm or greater, and a width 410 in the x-direction of about 600 nm to about 800 nm, such as about 700 nm. As such, the SB side shields 404a, 404b have a height to width ratio of about 1 or greater. The RSB structure 406 has a height 414 in the z-direction greater than about 200 nm, and a width 412 in the x-direction of about 10 nm to about 30 nm. The RSB structure 406 has a height to width ratio of about greater than 6. The sensor 402 has the same width 412 as the RSB structure 406. Thus, the RSB structure 406 has a greater height than width. This improves the magnetic stability of the read head 400 and improves asymmetric control through shape anisotropy.

In the read head 450 of FIG. 4B, the SB side shields 404a, 404b each has a height 458 in the z-direction of about 100 nm, and a width 460 in the x-direction of about 600 nm to about 800 nm, such as about 700 nm. As such, the SB side shields 404a, 404b have a height to width ratio of about 0.14, where a track-width (cross-track direction) of the SB side shields 404a, 404b is greater than the height 458 (stripe height direction). The RSB structure 406 has a height 464 in the z-direction of about 100 nm or more, and a width 462 in the x-direction of about 10 nm to about 30 nm. The sensor 402 has the same width 462 as the RSB structure 406. Thus, the SB side shields 404a, 404b have a greater width than height. The stability of the SB side shields 404a, 404b having a greater width than height improves magnetic stability of the read head 450 and asymmetric control through shape anisotropy.

In the read head 475 of FIG. 4C, the SB side shields 404a, 404b each has an L-like shape, where the SB side shields 404a, 404b each comprise a first portion 405a disposed at the MFS and a second portion 405b disposed adjacent to the RSB structure 406 recessed from the MFS. The first portion 405a has a height 482 in the z-direction of about 20 nm to about 40 nm, and a width 480 in the x-direction of about 250 nm or greater. The second portion 405b has a height 478 in the z-direction of about 1 nm to about 500 nm, and a width 484 in the x-direction of about 1 nm to about 50 nm. The height 482 of the first portion 405a disposed adjacent to the sensor 402 is equal to or greater than a height of the sensor 402.

The RSB structure 406 has a height 488 in the z-direction of about 200 nm or greater, and a width 486 in the x-direction of about 10 nm to about 30 nm. The sensor 402 has the same width 486 as the RSB structure 406. Thus, the SB side shields 404a, 404b have a greater width than height for the first portion 405a, and have a greater height than width for the second portion 405b. In the meantime, the RSB structure 406 has a greater height than width. This improves magnetic stability of the read head 475 and asymmetric control through shape anisotropy.

FIGS. 5A-5B illustrate MFS views of read heads 500, 550, according to various embodiments. The read heads 500, 550 may each individually be a part of the magnetic media drive 100 of FIG. 1. The read heads 500, 550 may each individually be a part of the read/write head 200 of FIG. 2, such as the read head 211. The read heads 500, 550 may each individually be, or be a part of, the read heads 400, 450, 475 of FIGS. 4A-4C. Thus, FIGS. 4A-4C may be used in combination with FIGS. 5A-5B.

The read head 500 comprises a first shield 520, the sensor 402 and the SB side shields 404a, 404b disposed on the first shield 520, and a second shield 548 disposed on the sensor 402 and the SB side shields 404a, 404b. The first shield 520 is a pinned SAF shield. The first shield 520 comprises a first shield layer 522, an anti-ferromagnetic (AFM) layer 524 disposed on the first shield layer 522, a second shield layer 526 disposed on the AFM layer 524, an anti-ferromagnetically coupled (AFC) layer 528 disposed on the second shield layer 526, and a magnetic seed layer 530 disposed on the AFC layer 528. A pinning direction of the AFM layer 524 and the magnetization direction of the second shield layer 526 are the same, such as in the x-direction. The magnetic seed layer 530 has an anti-parallel or opposite magnetization, such as in the −x-direction, than the second shield layer 526. The first shield layer 522 comprises NiFe or NiFeCr, for example, the AFM layer 524 comprises IrMn, FeMn, or PtMn, and the second shield layer 526 comprises a multilayer of NiFe, CoFe, or a combination thereof, with an optional dusting of Hf, B, and the like. The AFC layer 528 comprises Ru, and the magnetic seed layer 530 comprises a multilayer of NiFe, CoFe, or a combination thereof, with an optional dusting of Hf, B, and the like.

The sensor 402 comprises a non-magnetic seed layer 538 disposed on the magnetic seed layer 530 of the first shield 520 (a portion of the magnetic seed layer 530 may be considered part of the sensor 402), a first free layer 540 disposed on the seed layer 538, a barrier layer 542 disposed on the first free layer 540, a second free layer 544 disposed on the barrier layer 542, and a cap layer 546 disposed on the second free layer 544. The barrier layer 542 comprises MgO, and the cap layer 546 comprises Ta, Ru, CoHf, Ti, or a combination thereof. The first and second free layers 540, 544 each individually comprises CoFe, NiFe, CoHf, CoB, CoFeB, or a combination thereof.

The SB side shields 404a, 404b each individually comprises a first SB layer 532 disposed on and magnetically in contact with the magnetic seed layer 530, an non-magnetic layer 534 disposed on the first SB layer 532, and a second SB layer 536 disposed on the non-magnetic layer 534. The non-magnetic layer 534 comprises MgO, AlOx, SiN, SiOx, TaOx, TiOx, or a combination thereof (where x is a numeral greater than 1), and has a thickness in the y-direction of about 1 nm to about 3 nm. The non-magnetic layer 534 is aligned with the barrier layer 542 in the x-direction. The first and second SB layers 532, 536 each individually comprises CoFe, NiFe, CoHf, CoB, CoFeB, or a combination thereof, and the first and second SB layers 532, 536 are magnetically decoupled. The second shield 548 comprises a multilayer of NiFe, CoFe, or a combination thereof, with an optional dusting of Hf, B, and the like. Insulating layers 549 are disposed between the sensor 402 and the SB side shields 404a, 404b. The first free layer 540 is disposed adjacent to the first SB layer 532, and the second free layer 544 is disposed adjacent to the second SB layer 536.

The first and second SB layers 532, 536 are magnetically decoupled. The first SB layer 532 has a same magnetization direction as the magnetic seed layer 530 (i.e., parallel). The second SB layer 536 has an anti-parallel or opposite magnetization direction to the first SB layer 532. The second shield 548 has a parallel magnetization direction to the second SB layer 536. The non-magnetic layer 534 ensures electrical isolation across the first SB layer 532 and the second SB layer 536 is maintained.

The pinned SAF first shield 520, the first SB layer 532 being disposed in contact with the magnetic seed layer 530, the second SB layer 536 being in contact with the second shield 548, and first and second SB layers 532, 536 being magnetically decoupled reduces any domain walls created in the first and/or second SB layer(s) 532, 536. As such, the anti-parallel magnetization directions of the first and second SB layers 532, 536 is maintained, ensuring the read head 500 is able to accurately read data.

The read head 550 of FIG. 5B is similar to the read head 500 of FIG. 5A; however, the first and second shields 570, 572 are different. The read head 550 comprises a pinned first shield 570 and a SAF pinned second shield 572, where the sensor 402 and the SB side shields 404a, 404b are disposed between the first and second shields 570, 572. The first shield 522 comprises the first shield layer 522, the AFM layer 524 disposed on the first shield layer 522, and the magnetic seed layer 530 disposed on the first shield layer 522. The first SB layer 532 is disposed magnetically and electrically in contact with the magnetic seed layer 530. A pinning direction of the AFM layer 524, a magnetization direction of the magnetic seed layer 530, and a magnetization direction of the first SB layer 532 are parallel along a cross-track direction (e.g., the x-direction).

The second shield 572 comprises a third shield layer 552, an AFC layer 554 disposed on the third shield layer 552, and a fourth shield layer 556 disposed on the AFC layer 554. The AFC layer 554 comprises Ru, and the third and fourth shield layers 552, 556 each individually comprises a multilayer of NiFe, CoFe, or a combination thereof, with an optional dusting of Hf, B, and the like. The third shield layer 552 has an anti-parallel or opposite magnetization direction to the fourth shield layer 556, and the fourth shield layer 556 has a same magnetization direction as the first SB layer 532, the magnetic seed layer 530, and the AFM layer 524. The third shield layer 552 has a same magnetization direction as the second SB layer 536.

The pinned first shield 570, the pinned second shield 572, the first SB layer 532 being disposed in contact with the magnetic seed layer 530, the second SB layer 536 being in contact with the third shield layer 552, and first and second SB layers 532, 536 being magnetically decoupled reduces any domain walls created in the first and/or second SB layer(s) 532, 536. As such, the anti-parallel magnetization directions of the first and second SB layers 532, 536 is maintained, ensuring the read head 550 is able to accurately read data.

Therefore, the shape anisotropy of the SB side shields is increased with minimal impact on the RSB structure, including at least one pinned SAF shield, and having the first SB layer be magnetically and electrically in contact with the magnetic seed layer, any domain walls created in the first SB layer are reduced or weakened. As such, the anti-parallel magnetization directions of the first and second SB layers is maintained, increasing magnetic stability and asymmetric control in the read head.

In one embodiment, a read head comprises a first shield layer, an anti-ferromagnetic (AFM) layer disposed on the first shield layer, a magnetic seed layer disposed over the AFM layer, a dual free layer (DFL) sensor disposed over the magnetic seed layer at a media facing surface (MFS), soft bias (SB) side shields disposed adjacent to the DFL sensor, each of the SB side shields comprising: a first SB layer disposed in contact with the magnetic seed layer, a non-magnetic layer disposed in contact with the first SB layer, and a second SB layer disposed in contact with the non-magnetic layer, a second shield layer disposed over the DFL sensor and SB side shields, and a rear soft bias (RSB) structure disposed adjacent to the DFL sensor and SB side shields, the RSB structure being recessed from the MFS.

The read head further comprises a third shield layer disposed on the AFM layer, and an anti-ferromagnetically coupled (AFC) layer disposed in contact with the third shield layer and the magnetic seed layer. The read head further comprises an anti-ferromagnetically coupled (AFC) layer disposed on the second shield layer, and a third shield layer disposed on the AFC layer. The RSB structure has a greater height than a width. The SB side shields have an L-like shape, the SB side shields comprising a first portion disposed at the MFS and a second portion disposed adjacent to the RSB structure, wherein the first portion has a first height and a first width, and the second portion has a second height and a second width, the second height being greater than the first height, and the first width being greater than the second width. The non-magnetic layer comprises MgO, AlOx, SiN, SiOx, TaOx, TiOx, or a combination thereof, where x is a numeral greater than 1. A magnetic recording device comprises the read head.

In another embodiment, a read head comprises a first shield comprising: an anti-ferromagnetic (AFM) layer, a first shield layer disposed on the AFM layer, an anti-ferromagnetically coupled (AFC) layer disposed on the first shield layer, and a magnetic seed layer disposed on the AFC layer, a dual free layer (DFL) sensor disposed on the first shield at a media facing surface (MFS), soft bias (SB) side shields disposed adjacent to the DFL sensor, each of the SB side shields comprising: a first SB layer disposed in contact with the magnetic seed layer, a non-magnetic layer disposed in contact with the first SB layer, and a second SB layer disposed in contact with the non-magnetic layer, a second shield disposed over the DFL sensor and SB side shields, and a rear soft bias (RSB) structure disposed adjacent to the DFL sensor and SB side shields, the RSB structure being recessed from the MFS.

The RSB structure has a greater height than a width. The SB side shields have an L-like shape, the SB side shields comprising a first portion disposed at the MFS and a second portion disposed adjacent to the RSB structure, wherein the first portion has a first height and a first width, and the second portion has a second height and a second width, the second height being greater than the first height, and the first width being greater than the second width. The RSB structure has a height to width ratio of about 6 or higher. The magnetic seed layer comprises a multilayer of NiFe, CoFe, or a combination thereof, with an optional dusting of Hf, B, and the like. The magnetic seed layer has an anti-parallel magnetization direction to the first shield layer, the first SB layer has a parallel magnetization direction to the magnetic seed layer, the second SB layer has an anti-parallel magnetization direction to the first SB layer, and the second shield has a parallel magnetization to the second SB layer. The non-magnetic layer comprises MgO, AlOx, SiN, SiOx, TaOx, TiOx, or a combination thereof, where x is a numeral greater than 1. A magnetic recording device comprises the read head.

In yet another embodiment, a read head comprises a first shield comprising: an anti-ferromagnetic (AFM) layer, and a magnetic seed layer disposed over the AFM layer, a dual free layer (DFL) sensor disposed on the first shield at a media facing surface (MFS), soft bias (SB) side shields disposed adjacent to the DFL sensor, each of the SB side shields comprising: a first SB layer disposed in contact with the magnetic seed layer, a non-magnetic spacer disposed on the first SB layer, and a second SB layer disposed on the non-magnetic spacer, a second shield disposed over the DFL sensor and SB side shields, the second shield comprising: a first shield layer, an anti-ferromagnetically coupled (AFC) layer disposed on the first shield layer, and a second shield layer disposed in contact with the AFC layer, and a rear soft bias (RSB) structure disposed adjacent to the DFL sensor and SB side shields, the RSB structure being recessed from the MFS.

The RSB structure has a greater height than a width. The non-magnetic layer comprises Ru. The SB side shields comprise a first portion disposed at the MFS, the first portion having a first height and a first width, and a second portion recessed from the MFS, the second portion having a second height greater than the first height and a second width less than the first width. The DFL sensor comprises: a seed layer, a first free layer disposed on the seed layer, a barrier layer disposed on the first free layer, a second free layer disposed on the barrier layer, and a cap layer disposed on the second free layer. The first free layer is disposed adjacent to the first SB layer, and wherein the second free layer is disposed adjacent to the second SB layer. The non-magnetic spacer is aligned with the barrier layer. The magnetic seed layer has a parallel magnetization direction to a pinning direction of the AFM layer, the first SB layer has a parallel magnetization direction to the magnetic seed layer, the second SB layer has an anti-parallel magnetization direction to the first SB layer, the first shield layer has a parallel magnetization direction to the second SB layer, and the second shield layer has an anti-parallel magnetization direction to the first shield layer. The non-magnetic layer comprises MgO, AlOx, SiN, SiOx, TaOx, TiOx, or a combination thereof, where x is a numeral greater than 1. A magnetic recording device comprises the read head.

While the foregoing is directed to embodiments of the present disclosure, other and further embodiments of the disclosure may be devised without departing from the basic scope thereof, and the scope thereof is determined by the claims that follow.

1. A read head, comprising:
a first shield layer;
an anti-ferromagnetic (AFM) layer disposed on the first shield layer;
a magnetic seed layer disposed over the AFM layer;
a dual free layer (DFL) sensor disposed over the magnetic seed layer at a media facing surface (MFS);
soft bias (SB) side shields disposed adjacent to the DFL sensor, each of the SB side shields comprising:
a first SB layer disposed in contact with the magnetic seed layer;
a non-magnetic layer disposed in contact with the first SB layer; and
a second SB layer disposed in contact with the non-magnetic layer;
a second shield layer disposed over the DFL sensor and SB side shields; and
a rear soft bias (RSB) structure disposed adjacent to the DFL sensor and SB side shields, the RSB structure being recessed from the MFS.

2. The read head of claim 1, further comprising:
a third shield layer disposed on the AFM layer; and
an anti-ferromagnetically coupled (AFC) layer disposed in contact with the third shield layer and the magnetic seed layer.

3. The read head of claim 1, further comprising:
an anti-ferromagnetically coupled (AFC) layer disposed on the second shield layer; and
a third shield layer disposed on the AFC layer.

4. The read head of claim 1, wherein the RSB structure has a greater height than a width.

5. The read head of claim 1, wherein the SB side shields have an L-like shape, the SB side shields comprising a first portion disposed at the MFS and a second portion disposed adjacent to the RSB structure, wherein the first portion has a first height and a first width, and the second portion has a second height and a second width, the second height being greater than the first height, and the first width being greater than the second width.

6. The read head of claim 1, wherein the non-magnetic layer comprises MgO, AlOx, SiN, SiOx, TaOx, TiOx, or a combination thereof, where x is a numeral greater than 1.

7. A magnetic recording device comprising the read head of claim 1.

8. A read head, comprising:
a first shield comprising:
an anti-ferromagnetic (AFM) layer;
a first shield layer disposed on the AFM layer;
an anti-ferromagnetically coupled (AFC) layer disposed on the first shield layer; and
a magnetic seed layer disposed on the AFC layer;
a dual free layer (DFL) sensor disposed on the first shield at a media facing surface (MFS);
soft bias (SB) side shields disposed adjacent to the DFL sensor, each of the SB side shields comprising:
a first SB layer disposed in contact with the magnetic seed layer;
a non-magnetic layer disposed in contact with the first SB layer; and
a second SB layer disposed in contact with the non-magnetic layer;
a second shield disposed over the DFL sensor and SB side shields; and
a rear soft bias (RSB) structure disposed adjacent to the DFL sensor and SB side shields, the RSB structure being recessed from the MFS.

9. The read head of claim 8, wherein the RSB structure has a greater height than a width.

10. The read head of claim 8, wherein the SB side shields have an L-like shape, the SB side shields comprising a first portion disposed at the MFS and a second portion disposed adjacent to the RSB structure, wherein the first portion has a first height and a first width, and the second portion has a second height and a second width, the second height being greater than the first height, and the first width being greater than the second width.

11. The read head of claim 8, wherein the RSB structure has a height to width ratio of about 6 or higher.

12. The read head of claim 8, wherein the magnetic seed layer comprises a multilayer of NiFe, CoFe, or a combination thereof, with an optional dusting of Hf, B, and the like.

13. The read head of claim 8, wherein:
the magnetic seed layer has an anti-parallel magnetization direction to the first shield layer,
the first SB layer has a parallel magnetization direction to the magnetic seed layer,
the second SB layer has an anti-parallel magnetization direction to the first SB layer, and
the second shield has a parallel magnetization to the second SB layer.

14. The read head of claim 8, wherein the non-magnetic layer comprises MgO, AlOx, SiN, SiOx, TaOx, TiOx, or a combination thereof, where x is a numeral greater than 1.

15. A magnetic recording device comprising the read head of claim 8.

16. A read head, comprising:
a first shield comprising:
an anti-ferromagnetic (AFM) layer; and
a magnetic seed layer disposed over the AFM layer;
a dual free layer (DFL) sensor disposed on the first shield at a media facing surface (MFS);
soft bias (SB) side shields disposed adjacent to the DFL sensor, each of the SB side shields comprising:
a first SB layer disposed in contact with the magnetic seed layer;
a non-magnetic spacer disposed on the first SB layer; and
a second SB layer disposed on the non-magnetic spacer;
a second shield disposed over the DFL sensor and SB side shields, the second shield comprising:
a first shield layer;
an anti-ferromagnetically coupled (AFC) layer disposed on the first shield layer; and
a second shield layer disposed on the AFC layer; and
a rear soft bias (RSB) structure disposed adjacent to the DFL sensor and SB side shields, the RSB structure being recessed from the MFS.

17. The read head of claim 16, wherein the RSB structure has a greater height than a width.

18. The read head of claim 16, wherein the RSB structure has a height to width ratio of about 6 or higher.

19. The read head of claim 16, wherein the non-magnetic layer comprises Ru.

20. The read head of claim 16, wherein the SB side shields comprise a first portion disposed at the MFS, the first portion having a first height and a first width, and a second portion recessed from the MFS, the second portion having a second height greater than the first height and a second width less than the first width.

21. The read head of claim 16, wherein the DFL sensor comprises:
a seed layer;
a first free layer disposed on the seed layer;
a barrier layer disposed on the first free layer;
a second free layer disposed on the barrier layer; and
a cap layer disposed on the second free layer.

22. The read head of claim 21, wherein the first free layer is disposed adjacent to the first SB layer, wherein the second free layer is disposed adjacent to the second SB layer, and wherein the non-magnetic insulating spacer is aligned with the barrier layer.

23. The read head of claim 16, wherein:
the magnetic seed layer has a parallel magnetization direction to a pinning direction of the AFM layer,
the first SB layer has a parallel magnetization direction to the magnetic seed layer,
the second SB layer has an anti-parallel magnetization direction to the first SB layer,
the first shield layer has a parallel magnetization direction to the second SB layer, and
the second shield layer has an anti-parallel magnetization direction to the first shield layer.

24. The read head of claim 16, wherein the non-magnetic layer comprises MgO, AlOx, SiN, SiOx, TaOx, TiOx, or a combination thereof, where x is a numeral greater than 1.

25. A magnetic recording device comprising the read head of claim 16.
